(19) United States
(12) Patent Application Publication
(10) Pub. No.: US 2010/0076960 A1
(43) Pub. Date: Mar. 25, 2010

(54) METHOD AND SYSTEM FOR DYNAMICALLY GENERATING AND FILTERING REAL-TIME DATA SEARCH RESULTS IN A MATRIX DISPLAY

(75) Inventors: Patrick Sarkissian, New York, NY (US); Matthew Mason, Phoenix, AZ (US); Benjamin Ursu, Phoenix, AZ (US)

Correspondence Address: PERKINS COIE LLP, P.O. BOX 1208, SEATTLE, WA, 98111-1208, US

(73) Assignee: Sarkissian Mason, New York, NY (US)

(21) Appl. No.: 12/563,989

(22) Filed: Sep. 21, 2009

Related U.S. Application Data
(60) Provisional application No. 61/098,686, filed on Sep. 19, 2008.

(51) Int. Cl. G06F 17/30

(52) U.S. Cl. 707/722; 707/E17.109

(57) ABSTRACT

A method and system for dynamically generating and filtering real-time data search results in a matrix display, filtered by client-side data manipulation. The method includes, responsive to a search request, retrieving a set of search results, wherein each search result is associated with an image. The method includes filtering the search results based on client-side manipulation of search results criteria. The method includes displaying a matrix of the associated search results and images, wherein each image is automatically resized, in part, based on the number of search results. The method includes, responsive to client-side manipulation of search result criteria, removing irrelevant search results and resizing remaining result images, in part, based on the number of remaining search results.

### CROSS REFERENCE TO RELATED APPLICATIONS

This application claims priority to provisional application No. 61/098,686 entitled “METHOD AND SYSTEM FOR DYNAMICALLY GENERATING AND FILTERING REAL-TIME DATA SEARCH RESULTS IN A MATRIX DISPLAY”, filed September 19, and which is incorporated herein by reference.

### BACKGROUND

Online shopping is analogous to physical shopping, which involves buying products or services at a brick-and-mortar retailer. Instead of a physical location that users must visit, online shopping takes place over a network carrying digital information, such as the Internet or other networks. For example, online shopping can take place on an online merchant's website, which presents a front-end interface to users and a back-end interface to billing and fulfilment. Consumers can purchase products or services from an online merchant for delivery via various methods, such as by courier or other delivery services.

Shopping aggregators, also known as meta search engines, are configured search multiple online merchants for a user-specified product. This benefits users by allowing multiple online merchants to be searched through one interface. Product information and pricing can be retrieved as search results. The search results are displayed to the user, and can enable the user to quickly identify where a product is available at the best price or best terms.

Meta search engines can be programmed to only search pre-selected retailer websites. For example, retailer websites can be pre-selected for reliability, trustworthiness, inventory, or other factors. This allows a meta search engine to provide pricing on products from reliable or trusted merchants.

Search results can be filtered or sorted by the meta search engines through various selection criteria, such as price, product characteristics, or other criteria. This allows a user to quickly filter out irrelevant products from the search results. This also allows the user to view the search results in ascending or descending order based on the selection criteria.

Search results can be displayed to the user in a variety of formats, such as a text description, a thumbnail and description, a thumbnail, etc. Thumbnail images can be of a fixed size. Unfortunately, if many search results are returned, the associated thumbnail images can span multiple pages.

While search results can be filtered and otherwise organized using separate methods, they are not visually related and require the user to cross reference different search result methods and data sources to make a well informed search selection decision. In this particularly the case for online shopping.

Thus, there exists a need to provide a direct visual, efficient means for comparing search results including, for this case, product images and information from one source.

### BRIEF DESCRIPTION OF DRAWINGS

FIG. 1 illustrates an example server for generating a matrix view of search results.

FIG. 2 illustrates an example workstation for generating a matrix view of search results.

FIG. 3 illustrates an example system for generating a matrix view of search results.

FIG. 4A illustrates an example procedure for generating a matrix view of search results.

FIG. 4B illustrates an example procedure for setting up product data aggregation.

FIG. 4C illustrates an example procedure for aggregating and filtering search results.

FIG. 5A illustrates a first example screen shot of a matrix view of search results.

FIG. 5B illustrates a second example screen shot of a matrix view of search results once criteria selection has been applied.

FIG. 5C illustrates a third example screen shot of a matrix view of search results once additional criteria selection has been applied.

FIG. 6 illustrates an example data structure for mapping search results.

### DETAILED DESCRIPTION

A set of search results are retrieved and displayed responsive to a user search request. For example, with online shopping, the user search request can be for a category of products, such as “digital camera”, “sports car”, “laptop computer”, etc. Each search result is associated with product details and a thumbnail image. The thumbnail images are displayed to the user in a matrix view, where the thumbnail images are resized depending, in part, on a number of search results retrieved and thumbnail images to be displayed.

The set of search results is updated responsive to client-side data manipulation, such as additional search criteria entered by the user. The set of search results changes in real-time. Similarly, the displayed thumbnail images also change along with the search results. For example, additional search criteria can include product brand, make, price, features, etc. When the search criteria are adjusted, the set of search results changes, and the thumbnail images are resized and rearranged in real-time as appropriate. Responsive to a user selection of a product, product details are displayed and a purchase option is offered.

Providing a matrix view of product thumbnails has substantial benefits in online shopping applications. Such a site is distinctly different from other online shopping sites and significantly improves a user shopping experience when compared to traditional consumer shopping sites. The matrix view provides a simple, uncluttered design. The search results are immediately updated based on user-inputted search criteria that allow the user to quickly filter search results to find most relevant products.

It will be appreciated that search results and data can include any information, including product images and product information. Product images can be of any size or format, including small thumbnail images or large full-sized images. Search results can include a text product description and a thumbnail image of the product.

It will be appreciated that the methods and systems discussed herein can be applied to e-commerce and online shopping applications, as well as any other type of search applications.

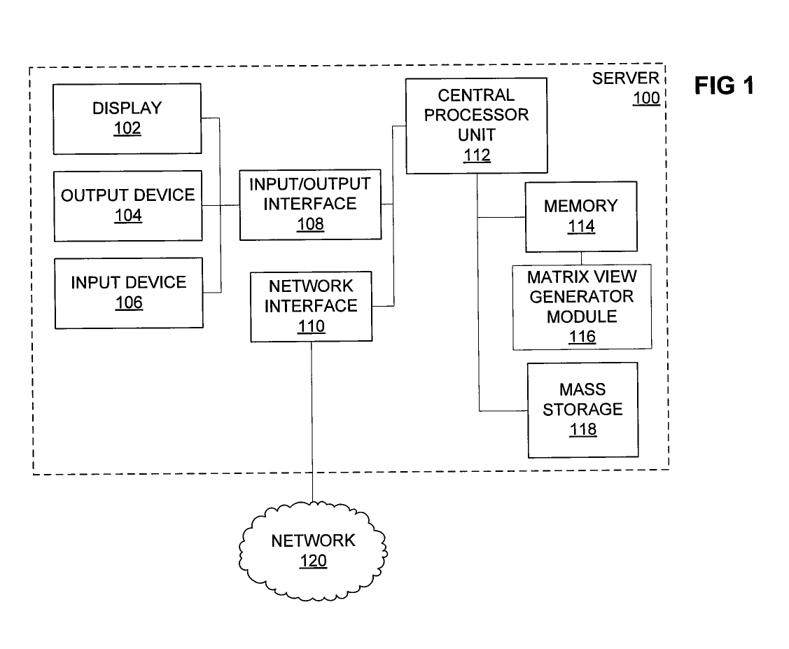

FIG. 1 illustrates an example server for generating a matrix view of search results. A server 100 is configured to receive search requests from a user and service the search requests by executing searches on an accessible data store. The server 100 also transmits search result thumbnails for display at a client, as discussed below. For example, the server 100 can be a standard computing server configured to communicate over one or more networks and execute a matrix view generator module 116. Alternatively, the server 100 can be any computing device.

The server 100 includes a display 102. The display 102 can be physical equipment or hardware that displays viewable images, graphics, and text generated by the server 100 to a system administrator or user. For example, the display 102 can be a cathode ray tube or a flat panel display such as a TFT LCD. The display 102 includes a display surface, circuitry to generate a viewable picture from electronic signals sent by the server 100, and a physical enclosure or case. The display 102 can interface with an input/output interface 108, which converts data from a central processor unit 112 to a format compatible with the display 102.

The server 100 includes one or more output devices 104. The output device 104 can be any hardware used to communicate outputs to the user. For example, the output device 104 can be devices for providing output to the system administrator.

The server 100 includes one or more input devices 106. The input device 106 can be any computer hardware used to receive inputs from the user. The input device 106 can include keyboards, mouse pointer devices, etc.

The server 100 includes an input/output interface 108. The input/output interface 108 can include logic and physical ports used to connect and control peripheral devices, such as output devices 104 and input devices 106. For example, the input/output interface 108 can allow input and output devices 104 and 106 to communicate with the server 100. The input and output devices 104 and 106 can be considered part of the server 100, as illustrated.

The server 100 includes a network interface 110. The network interface 110 includes logic and physical ports used to connect to one or more networks. For example, the network interface 110 can accept a physical network connection and interface between the network and the workstation by translating communications between the two. Example networks can include Ethernet, the Internet, or other physical network infrastructure.

Alternatively, the network interface 110 can be configured to interface with a wireless network. Example wireless networks can include Wi-Fi, Bluetooth, cellular, or other wireless networks. It will be appreciated that the server 100 can communicate over any combination of wired, wireless, or other networks.

The server 100 includes a central processing unit (CPU) 112. The CPU 112 can be an integrated circuit configured for mass-production and suited for a variety of computing applications. The CPU 112 can be mounted in a special-design socket on a motherboard within the server 100. The CPU 112 can execute instructions to control other workstation components. The CPU 112 can communicate with the other workstation components via a bus, a physical interchange, or other communication channel. It will be appreciated that any number of CPUs may be present in the server 100.

The server 100 includes a memory 114. The memory 114 can include volatile and non-volatile memory accessible to the CPU 112. The memory can be random access and provide fast access for graphics-related or other calculations. In an alternative embodiment, the CPU 112 can also include on-board cache memory for faster performance.

The server 100 includes a matrix view generator module 116 stored in memory 114 and executing on CPU 112. The module 116 can be configured to dynamically generate a matrix view of a set of thumbnail images for transmission, as discussed below.

The server 100 includes a mass storage 118. The mass storage 118 can be volatile or non-volatile storage configured to store large amounts of data. The mass storage 118 can be accessible to the CPU 112 via a bus, a physical interchange, or other communication channel. For example, the mass storage 118 can be a hard drive, a RAID array, flash memory, CD-ROMs, DVDs, HD-DVD or Blu-Ray mediums.

The server 100 communicates with a network 120 via the network interface 112. The network 120 can be as discussed above. The network 120 can be any network configured to carry digital information. For example, the network interface 110 can communicate over an Ethernet network, the Internet, a wireless network, a cellular data network, or any Local Area Network or Wide Area Network.

In the example of FIG. 1, in operation, the server 100 receives a search request from a client or workstation over the network 120, as discussed below. The search request is processed by the server 100 and a set of search results are retrieved. Each search result is associated with a thumbnail image and product details. The matrix view generator module receives the data set of search results for resizing and re-ordering, as discussed below. The set of search results are transmitted to the workstation over the network 120 for display to the user in a matrix format.

The matrix view generator module 116 resizes and re-orders the remaining search results for display to the user responsive to user inputs that add to or subtract from the set of search results (for example, by adding search criteria that filters out some search results or by adding search categories that increase a number of search results).

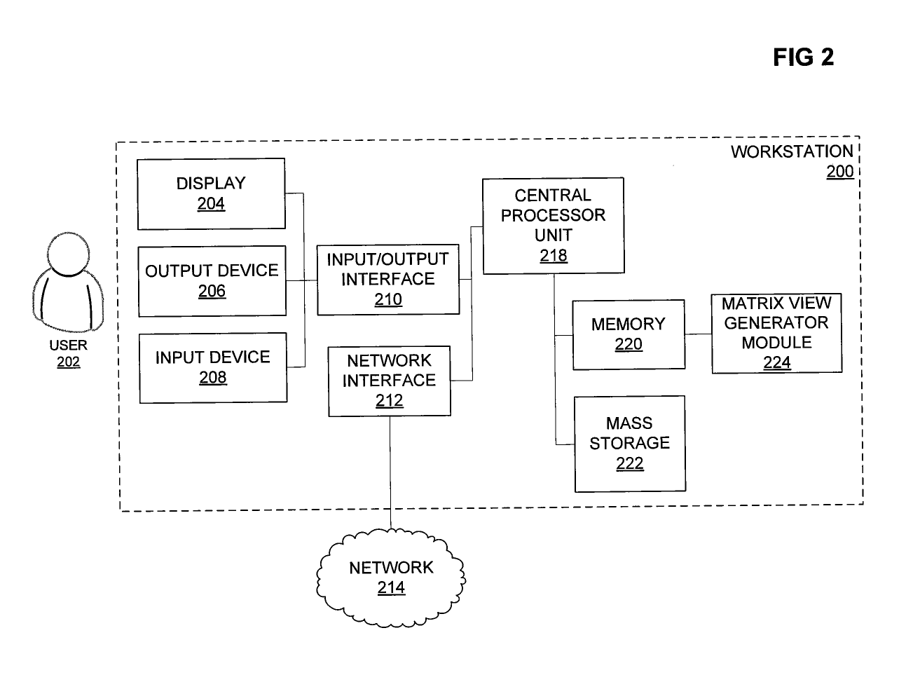

FIG. 2 illustrates an example workstation for generating a matrix view of search results. The workstation 200 can be configured to communicate with a server as illustrated in FIG. 1 to process user search requests and display search results to the user 202.

The workstation 200 can be a computing device such as a server, a personal computer, desktop computer, laptop, a personal digital assistant (PDA), a cellular phone, or other computing device. The workstation 200 is accessible to the user 202 and provides a computing platform for various applications.

The workstation 200 can include a display 204. The display 204 can be physical equipment that displays viewable images and text generated by the workstation 200. For example, the display 204 can be a cathode ray tube, a flat panel display such as a TFT LCD, or a LED screen. The display 204 includes a display surface, circuitry to generate a visual picture from electronic signals sent by the workstation 200, and an enclosure or case. The display 204 can interface with an input/output interface 220, which forwards data from the workstation 200 to the display 204.

The workstation 200 can include one or more output devices 206. The output device 206 can be hardware used to communicate outputs to the user.

The workstation 200 can include one or more input devices 208. The input device 208 can be any computer hardware used to translate inputs received from the user 202 into data usable by the workstation 200. The input device 208 can be, for example, keyboards, mouse pointer devices, etc.

The workstation 200 includes an input/output interface 210. The input/output interface 210 can include logic and physical ports used to connect and control peripheral devices, such as output devices 206 and input devices 208. For example, the input/output interface 210 can allow input and output devices 206 and 208 to connect to the workstation 200.

The workstation 200 includes a network interface 212. The network interface 212 includes logic and physical ports used to connect to one or more networks. For example, the network interface 212 can accept a physical network connection and interface between the network and the workstation by translating communications between the two. Example networks can include Ethernet, or other physical network infrastructure. Alternatively, the network interface 212 can be configured to interface with a wireless network. Alternatively, the workstation 200 can include multiple network interfaces for interfacing with multiple networks.

The workstation 200 communicates with a network 214 via the network interface 222. The network 214 can be any network configured to carry digital information. For example, the network 214 can be an Ethernet network, the Internet, a wireless network, a cellular data network, or any Local Area Network or Wide Area Network.

Alternatively, the workstation 200 can be a client device in communications with a server over the network 214. Thus, the workstation 200 can be configured for lower performance (and thus have a lower hardware cost) and the server provides necessary processing power and resources.

The workstation 200 communicates with a server 216 via the network interface 222 and the network 214. For example, the server 216 can execute billing software for receiving time entries from the user 202. For example, the server 216 can host a document management system accessible to the workstation 200.

The workstation 200 includes a central processing unit (CPU) 218. The CPU 218 can be an integrated circuit configured for mass-production and suited for a variety of computing applications. The CPU 218 can be installed on a motherboard within the workstation 200 and control other workstation components. The CPU 218 can communicate with the other workstation components via a bus, a physical interchange, or other communication channel.

The workstation 200 includes a memory 220. The memory 220 can include volatile and non-volatile memory accessible to the CPU 218. The memory can be random access and store data required by the CPU 218 to execute installed applications. In an alternative, the CPU 218 can include on-board cache memory for faster performance.

The workstation 200 includes mass storage 222. The mass storage 222 can be volatile or non-volatile storage configured to store data. The mass storage 222 can be accessible to the CPU 218 via a bus, a physical interchange, or other communication channel. For example, the mass storage 222 can be a hard drive, a RAID array, flash memory, CD-ROMs, DVDs, HD-DVD or Blu-Ray mediums.

The workstation 200 can include a matrix view generator module 224. In one embodiment, the workstation 200 can dynamically generate the matrix view of thumbnail images, as discussed below. The matrix view can be generated in the matrix view generator module 224.

In another embodiment, the matrix view can be generated at the server 216 for transmission to the workstation 200, which displays the matrix view to the user 202.

In operation, the workstation 200 can process a user 202 search request for transmission to an online merchant website, provided by a server as illustrated above. The matrix view generator module 224 interacts with the server to display dynamically generated thumbnail images to the user, as discussed.

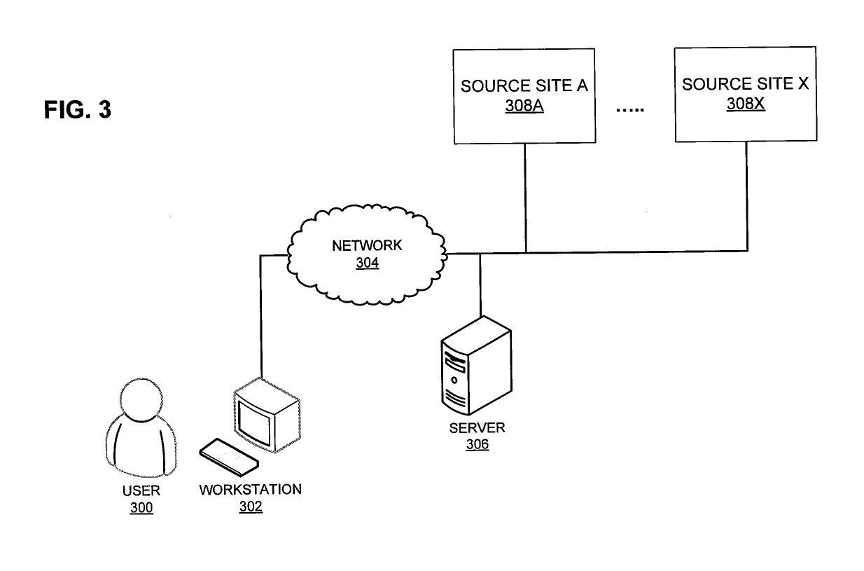

FIG. 3 illustrates an example system for generating a matrix view of search results. The system includes a user 300 interacting with a user interface on a workstation 302. The workstation 302 communicates over a network 304 with a server 306. The server 306 retrieves product information from one or more retailer websites 308.

The workstation 302 can be a computing device as illustrated in FIG. 2. The workstation 302 can be configured to provide a user interface, for example, via a web browser to the user.

The network 304 can be configured to carry digital information, similar to the networks discussed in FIGS. 1 and 2.

The server 306 can be a computing device as illustrated in FIG. 1. The server 306 can be configured to process search requests from the workstation 302, to retrieve search results, and to transmit thumbnail images associated with search results to the user 300, as discussed.

The source site A 308A and the source site X 308X can be, for example, online shopping websites that sell products over the Internet. The retailer websites 308 can include both online retailers and brand store sites, such as Best Buy, Circuit City, Sony, Canon, HP, Dell, etc. The source site 308 can be pre-selected by a server administrator for quality, reliability, and other characteristics.

It will be appreciated that while only two source sites are depicted, the server 306 can be configured to retrieve product information from any number of retailer websites. In one example embodiment, the source sites can be meta search sites.

It will be appreciated that a matrix view of thumbnail images can be generated at the workstation 302, the server 306, or a combination of the two responsive to user inputted search criteria.

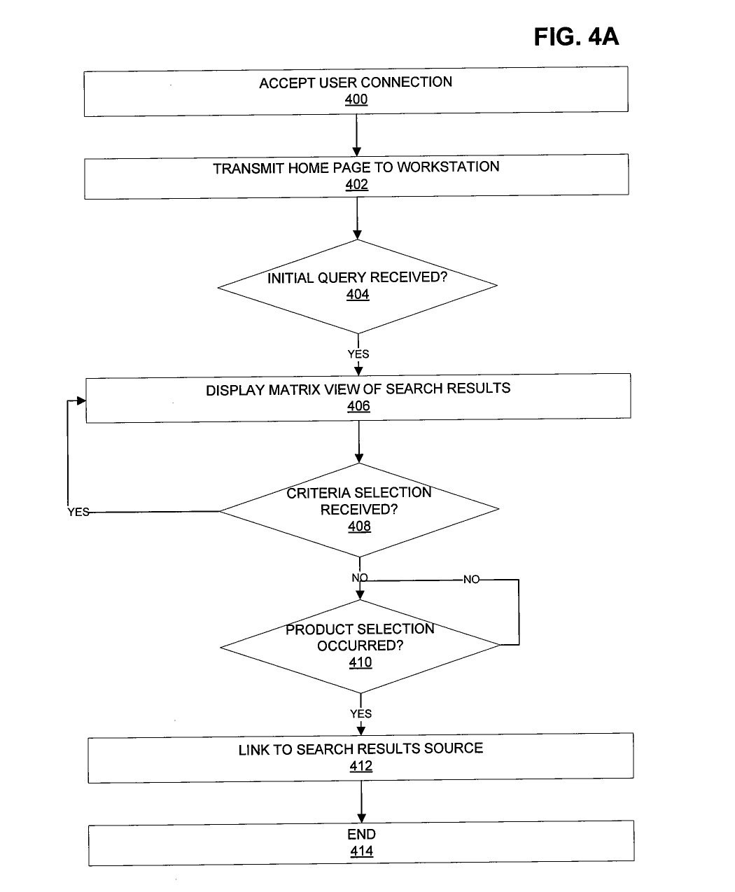

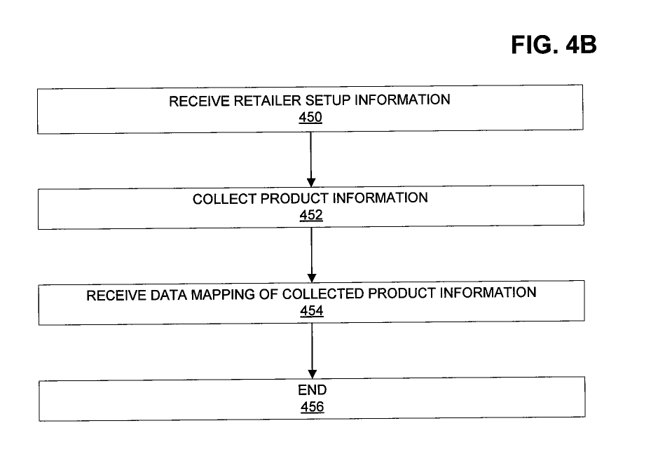

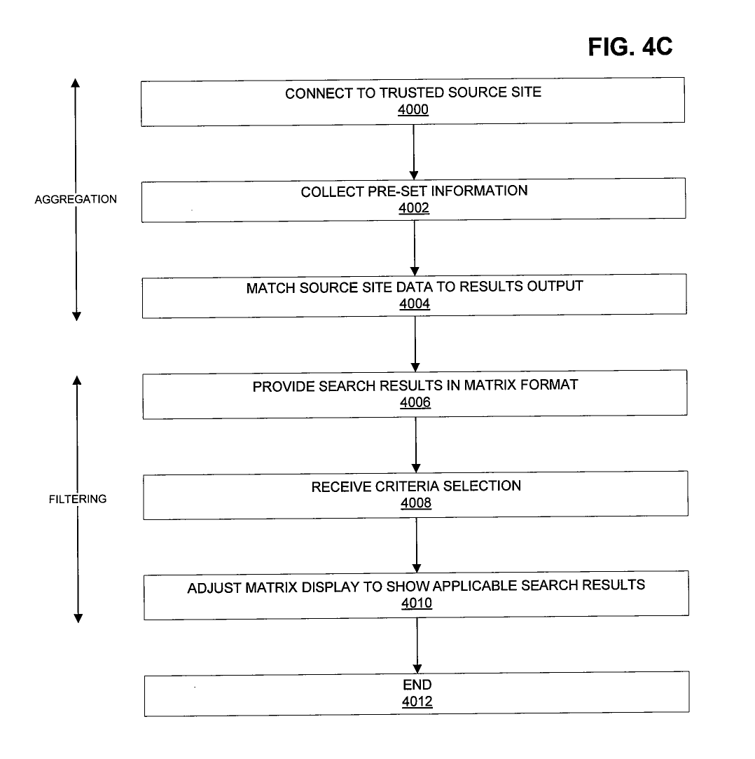

FIG. 4A illustrates an example procedure for generating a matrix view of search results. The procedure can execute on a server, as illustrated in FIG. 1. Responsive to user commands from a workstation, the server retrieves a set of search results and generates a matrix view of those results that includes imagery and text information.

In 400, the server accepts a user connection. For example, the server can provide a meta search website. The user can be required to input a username and password before access to the website is allowed. For example, all users can be required to register with the server before submitting search requests. In an alternative, a subset of the functionality discussed below can be available to guest users who are not registered or logged in.

In 402, the server can transmit a home page of the website to the workstation for display to the user. For example, the home page can display available product category selections.

In 404, the server tests whether an initial query has been received. For example, the initial query can be a category of products the user desires to view.

If an initial query has been received, the server proceeds to 406. If no initial query has been received, the server waits at 404.

In 406, the server displays search results responsive to the initial query. The server initiates a filtering function that produces only product data listed as part of the requested category. Once filtered, the products are displayed in a matrix format.

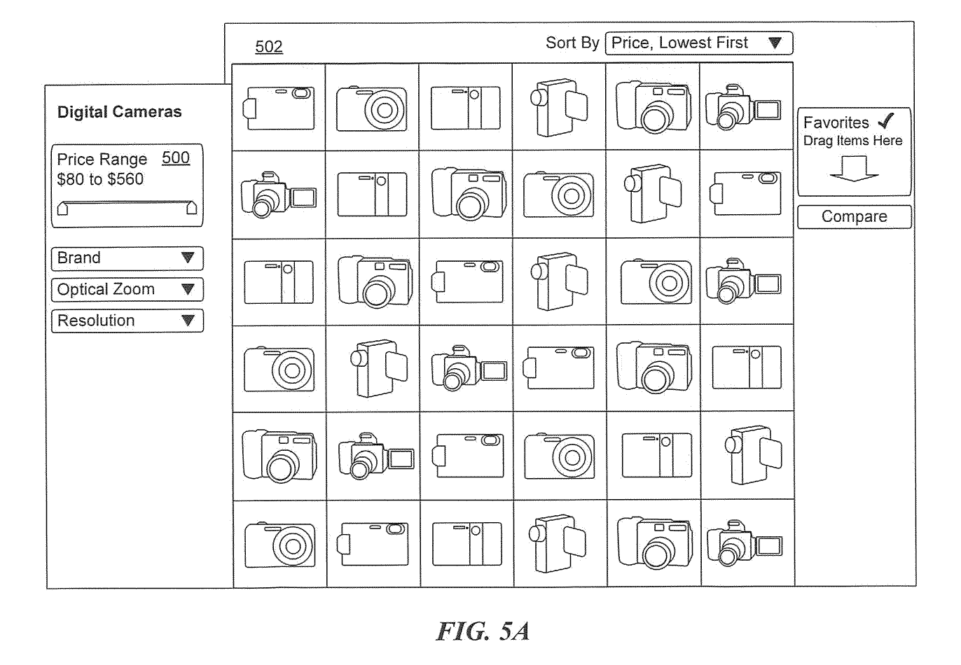

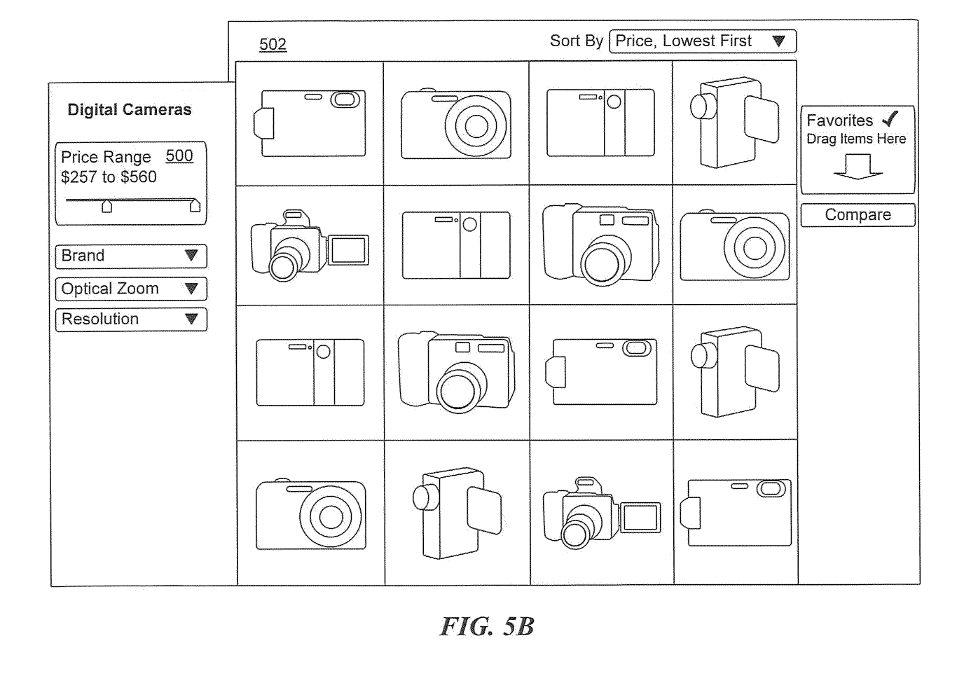

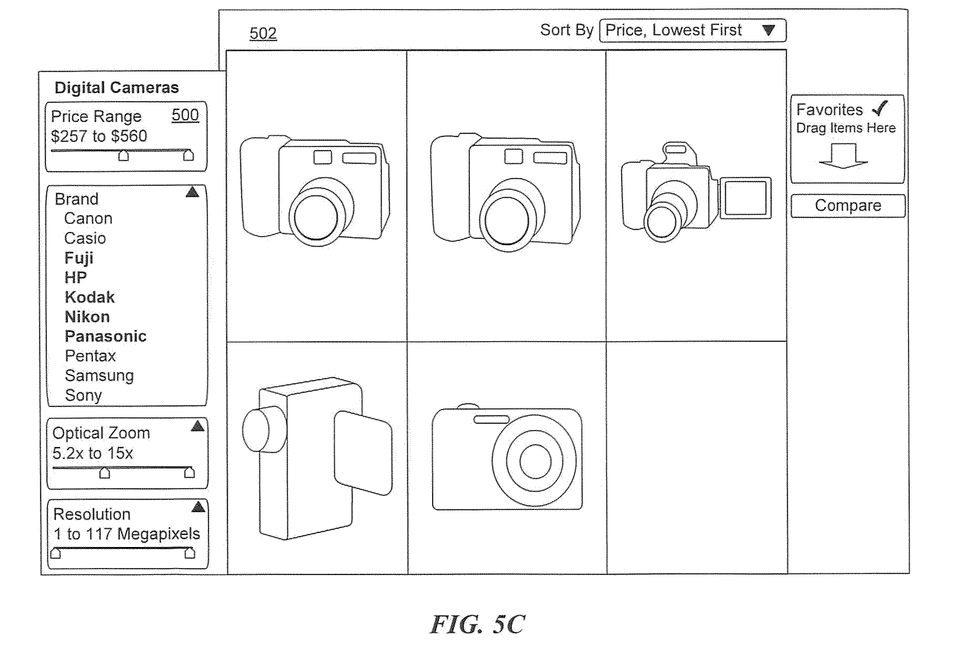

The matrix format can be a grid, where each square of the matrix is filled with the product thumbnail for a product within the requested category. The matrix and the product thumbnail images within each square dynamically expand and contract with the number of products displayed. For example, a matrix format can be as illustrated in FIG. 5A.

In 408, the server tests whether a criteria selection has been received. For example, search criteria can be one or more criteria selections received from the user that narrow a search request. The criteria selection can be made as a result of client-side data manipulation by the user.

Criteria selection can include product attributes that are unique for each type of product, but based on the product description data imported in from retailer sites. The user can slide criteria bars to the desired range, which causes the server to filter out any displayed products that fall outside the search criteria.

As the set of displayed products increases and decreases, the matrix view automatically adjusts by expanding and contracting. The displayed product thumbnail images are also automatically resized to fit within the squares of the matrix. For example, the matrix view of FIG. 5A can be adjusted with search criteria as illustrated in FIGS. 5B and 5C.

Each product category can include multiple product attributes, each attribute associated with a slider or selector. Use of multiple criteria bars further filters the product results, allowing a user to specify multiple criteria describing his product needs. Each additional criteria bar acts similarly to the first, filtering out products that do not meet the criteria selection.

Each product thumbnail image can provide a product details information popup window when the user mouse-overs the thumbnail image. The product details information popup window can display a brief product description including a product title and price.

In 410, the server tests whether a product selection has occurred. The user can select a product by clicking on a corresponding product thumbnail image.

If the user has selected a product, the server displays product details associated with the selected product. The product details page can display full product details and a purchase link. If no product has been selected, the server can proceed to 412.

In 412, the server redirects the user to a search results source. For example, the search results source can be the online retailer website from where the product information was retrieved.

In 414, the server exits the procedure.

FIG. 4B illustrates an example procedure for setting up product data aggregation. The procedure can execute on a server and allow system administrators to set up product information collection from retailer and other websites.

In 450, the server receives retailer setup information from system administrators. This ensures that any product information displayed is accurate and comes from a reliable, pre-screened source. For example, retailer websites can be selected for accurate pricing and inventory information.

In 452, the server collects product information from the selected retailer websites. A range of techniques can be used to collect product information, including (1) RSS feed from the retailer website; (2) API data collection; (3) web service data collection; (4) website scraping, and (5) manual input by the system administrators. In the data collection stage, all site data and/or product data is collected from the retailer site. Data not required for display by the server are filtered out and not stored by the server.

The server can automatically refresh product information periodically. If the product information is not successfully retrieved, the server can put periodically re-attempt the retrieval until the product information is retrieved. Data collection logs are also processed to document the collection time and updates for debugging or auditing purposes. If a connection cannot be established, the system administrator is notified who can modify the retailer setup information as necessary.

In 454, the server receives data mapping of the collected product information. The system administrator uses data mapping techniques to match the collected product information and converting it into a server-accessible format. Data mapping is done for the data feed imported from each retailer, as each retailer categorizes their data differently. The data mapping includes setting up one-to-one direct relationships between the data type imported from the retailer and the standard data type needed by the server. Once data mapping settings are set up for each retailer, the server automatically parses the collected product information into the server-accessible format.

In one embodiment, the system administrators create appropriate rules for data mapping the collected product information from each source site.

In 456, the server can exit the procedure.

FIG. 4C illustrates an example procedure for aggregating and filtering search results. The procedure can execute on a server as illustrated in FIG. 1.

In 4000, the server can connect to trusted source sites. The source sites can be pre-set by system administrators, as discussed above in FIG. 4B.

In 4002, the server can periodically collect pre-set information. For example, the server can collect product information from the trusted source sites every 12 hours. The product information can be collected with various mechanisms, as discussed above.

In 4004, the server can match source site data to results output. Because data retrieved from source site data can be in different formats, the retrieved data must be parsed and mapped into an internal data structure, as discussed elsewhere.

In 4006, the server can provide search results in a matrix format to a user. For example, each search result can be associated with an image, which is resized and displayed in a matrix of thumbnail images, as discussed elsewhere.

In 4008, the server can receive criteria selection. For example, criteria selection can be product characteristics and serve to filter the search results, as discussed elsewhere.

In 4010, the server can adjust a matrix display to show applicable search results. The received criteria selection of 4008 can be used to filter out irrelevant search results, producing only remaining search results relevant to a user search, as discussed elsewhere.

It will be appreciated that any number of criteria can be received in 4008 over a period of time, and each time criteria selection are received, the server adjusts the matrix display in 4010.

In 4012, the server can exit the procedure.

It will be appreciated that 4000, 4002, and 4004 can be an aggregation subroutine. It will be appreciated that 4006, 4008, and 4010 can be a filtering subroutine.

FIG. 5A illustrates a first example screen shot of a matrix view of search results. The screen shot includes 2 criteria selection inputs (product category and price range) 500 and a matrix 502 view of all the relevant search results.

The criteria selection inputs 500 can be slider boxes, clickable boxes or text, or other inputs for receiving user selections of desired criteria. The criteria selection inputs 500 can be based on product characteristics. For example, digital camera search results can be filtered by price, brand, optical zoom, and resolution. It will be appreciated that criteria can be setup specific to the type of search results generated.

As discussed above, matrix boxes (thumbnails in this case) are resized, in part, based on how many search results fit the selection criteria. In one example, the thumbnails are resized so that all products that fit the selection criteria are viewable to the user without scrolling.

FIG. 5B illustrates a second example screen shot of a matrix view of search results once criteria selection has been applied. The screen shot is similar to the screen shot illustrated in FIG. 5A except the price criteria selection of the criteria selection inputs 500 has been changed to $257 to $560.

As a result of this client-side data manipulation, some products are eliminated, and thus the matrix 502 is filled with new search results (only the relevant results to which the criteria apply). It will be appreciated that the thumbnails are automatically resized to be larger to take advantage of the smaller number of search results compared to the screen shot illustrated in FIG. 5A.

FIG. 5C illustrates a third example screen shot of a matrix view of search results once additional criteria selection has been applied. The screen shot is similar to the screen shots illustrated in FIGS. 5A and 5B, but this time, additional criteria have been selected, including brand zoom, etc. of the criteria selection inputs 500. As a result of this client-side data manipulation, some products are eliminated, and thus the matrix 502 is filled with the filtered relevant search results. It will be appreciated the thumbnails are automatically resized to be larger to take advantage of the smaller number of thumbnails compared to the screen shot illustrated in FIG. 5B.

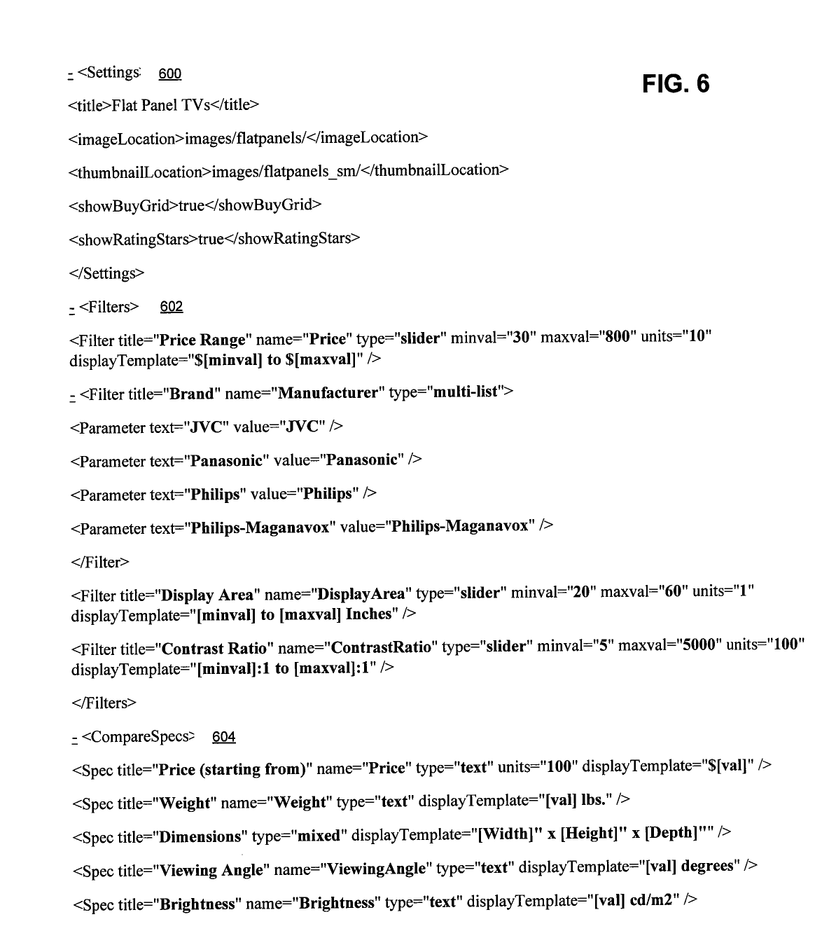

FIG. 6 illustrates an example data structure for mapping search results. The data mapping structure is expressed in Extended Markup Language (XML) and defines how search results of a product category search query are stored and displayed.

In this case, settings 600 define settings for the product category. Settings 600 can include a title of the category, a product image file location, a product thumbnail file location, whether to show a buy grid offering an option to purchase the product, and whether ratings of the source site or products should be displayed.

Filters 602 define criteria selection inputs as discussed above in FIG. 4A and other figures. For example, flat panel TVs can have criteria filters for a price range, a brand, a display area, and a contrast ratio.

Compare specifications 604 define product characteristics that can be compared between the products. For example, flat panel TVs can have product characteristic such as price, weight, dimensions, viewing angle, brightness, etc.

It will be appreciated that other information can be stored in the data structure that appears on the product (or search results) detail page. For example, product features, sorting options, and product information for individual products can all be stored in the data structure. Product information can include manufacturer, model, display type, display area, aspect ratio, viewing angle, contrast ratio, resolution, brightness, support for various resolutions, response time, TV support for HDTV, support for various inputs, speakers, support for audio output, power source, dimensions, product description, and retailer websites that sell the product.

As discussed above, one example embodiment of the present invention is a method for generating a matrix view of search results. The method includes, responsive to a search request, retrieving a set of search results, wherein each search result is associated with an image. The method includes displaying a matrix of the associated search results, wherein each associated search result (or image) is resized, in part, based on the total number of search results. The method includes, responsive to a change in the user search criteria, removing irrelevant search results and resizing remaining thumbnail images, in part, based on the number of remaining search results. The thumbnail images are automatically resized to maintain their original aspect ratio. The search results can be products for sale. The search request can include a product category and the search criteria include at least one of: a product brand, a product price, and a product characteristic. The method includes providing a transition effect that shows the matrix scaling action to display the remaining resized thumbnail images. The search request can be executed among a set of product information, wherein the product information is retrieved from various retailer websites. The method includes, responsive to a user selection of a search results (or image), displaying a search result (or ‘product’) details page, wherein that search result details (or product) details page is directly associated with the thumbnail image, and provides detailed information about that search result.

Another example embodiment of the present invention is a server for creating a functional music video. The system includes a memory storing a plurality of records. The system includes a network interface in communications with a client over a digital network. The system includes a processor. The processor can be configured to, responsive to receiving a search request from the client, retrieve a set of search results from the plurality of records stored in the memory, wherein each search result is associated with an image. The processor can be configured to transmit a matrix of the associated images to the client, wherein each associated image is resized, in part, based on a number of search results. The processor can be configured to, responsive to a set user search criteria, remove irrelevant search results and resizing remaining images in real-time, in part, based on a number of remaining search results. The images can be resized to maintain an original aspect ratio. The search results can be products for sale. The search request can include a product category and the search criteria include at least one of: a product brand, a product price, and a product characteristic. The processor can be configured to provide a transition effect including scaling the remaining resized search results and images. The plurality of records can be a set of product information retrieved in real-time from a set source site. The processor can be configured to, responsive to a user selection of at least one of: a search result and an image, display a product details page, wherein the product details page is directly associated with the image. The user search criteria can be received from a client through client-side data manipulation.

Another example embodiment of the present invention is a computer-readable storage medium including instructions adapted to execute a method for generating a matrix view of search results. The method includes, responsive to a search request, retrieving a set of search results, wherein each search result is associated with an image. The method includes displaying a matrix of the associated search results, wherein each associated search result (or image) is resized, in part, based on the total number of search results. The method includes, responsive to a change in the user search criteria, removing irrelevant search results and resizing remaining thumbnail images, in part, based on the number of remaining search results. The thumbnail images are automatically resized to maintain their original aspect ratio. The search results can be products for sale. The search request can include a product category and the search criteria include at least one of: a product brand, a product price, and a product characteristic. The method includes providing a transition effect that shows the matrix scaling action to display the remaining resized thumbnail images. The search request can be executed among a set of product information, wherein the product information is retrieved from various retailer websites. The method includes, responsive to a user selection of a search results (or image), displaying a search result (or ‘product’) details page, wherein that search result details (or product) details page is directly associated with the thumbnail image, and provides detailed information about that search result.

The specific embodiments described in this document represent examples or embodiments of the present invention, and are illustrative in nature rather than restrictive. In the above description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the present invention. Features and aspects of various embodiments may be integrated into other embodiments, and embodiments illustrated in this document may be implemented without all of the features or aspects illustrated or described. It will be appreciated to those skilled in the art that the preceding examples and embodiments are exemplary and not limiting.

While the system, apparatus and method have been described in terms of what are presently considered to be the most practical and effective embodiments, it is to be understood that the disclosure need not be limited to the disclosed embodiments. It is intended that all permutations, enhancements, equivalents, combinations, and improvements thereto that are apparent to those skilled in the art upon a reading of the specification and a study of the drawings are included within the true spirit and scope of the present invention. The scope of the disclosure should thus be accorded the broadest interpretation so as to encompass all such modifications and similar structures. It is therefore intended that the application includes all such modifications, permutations and equivalents that fall within the true spirit and scope of the present invention.

What is claimed is:

1. A method for generating a matrix view of search results, comprising:
responsive to a search request, retrieving a set of search results, wherein each search result is associated with an image;
displaying a matrix of the associated images, wherein each associated image is resized, in part, based on a number of search results; and
responsive to a set user search criteria, removing irrelevant search results and resizing remaining images in real-time, in part, based on a number of remaining search results.

2. The method of claim 1, wherein the images are resized to maintain an original aspect ratio.

3. The method of claim 1, wherein the search results are products for sale.

4. The method of claim 3, wherein the search request includes a product category and the search criteria include at least one of: a product brand, a product price, and a product characteristic.

5. The method of claim 1, further comprising:
providing a transition effect including scaling the remaining resized search results and images.

6. The method of claim 1, wherein the search request is executed among a set of product information, wherein the product information is retrieved in real-time from a set source site.

7. The method of claim 6, further comprising:
responsive to a user selection of at least one of: a search result and an image, displaying a product details page, wherein the product details page is directly associated with the image.

8. The method of claim 1, wherein the user search criteria are received from a client through client-side data manipulation.

9. A server for creating a functional music video, comprising:
a memory storing a plurality of records;
a network interface in communications with a client over a digital network; and
a processor, the processor configured to,
responsive to receiving a search request from the client, retrieve a set of search results from the plurality of records stored in the memory, wherein each search result is associated with an image,
transmit a matrix of the associated images to the client, wherein each associated image is resized, in part, based on a number of search results, and
responsive to a set user search criteria, remove irrelevant search results and resizing remaining images in real-time, in part, based on a number of remaining search results.

10. The server of claim 9, wherein the images are resized to maintain an original aspect ratio.

11. The server of claim 9, wherein the search results are products for sale.

12. The server of claim 11, wherein the search request includes a product category and the search criteria include at least one of: a product brand, a product price, and a product characteristic.

13. The server of claim 9, the processor further configured to,
provide a transition effect including scaling the remaining resized search results and images.

14. The server of claim 9, wherein the plurality of records is a set of product information retrieved in real-time from a set source site.

15. The server of claim 14, the processor further configured to,
responsive to a user selection of at least one of: a search result and an image, display a product details page, wherein the product details page is directly associated with the image.

16. The server of claim 9, wherein the user search criteria are received from a client through client-side data manipulation.

17. A computer-readable storage medium including instructions adapted to execute a method for generating a matrix view of search results, the method comprising:
responsive to a search request, retrieving a set of search results, wherein each search result is associated with an image;
displaying a matrix of the associated images, wherein each associated image is resized, in part, based on a number of search results; and
responsive to a set user search criteria, removing irrelevant search results and resizing remaining images in real-time, in part, based on a number of remaining search results.

18. The medium of claim 17, wherein the images are resized to maintain an original aspect ratio.

19. The medium of claim 17, wherein the search results are products for sale.

20. The medium of claim 19, wherein the search request includes a product category and the search criteria include at least one of: a product brand, a product price, and a product characteristic.

21. The medium of claim 17, the method further comprising:
providing a transition effect including scaling the remaining resized search results and images.

22. The medium of claim 17, wherein the search request is executed among a set of product information, wherein the product information is retrieved in real-time from a set source site.

23. The medium of claim 22, the method further comprising:
responsive to a user selection of at least one of: a search result and an image, displaying a product details page, wherein the product details page is directly associated with the image.

24. The medium of claim 17, wherein the user search criteria are received from a client through client-side data manipulation.
